(19) United States
(12) Patent Application Publication
(10) Pub. No.: US 2021/0141358 A1
(43) Pub. Date: May 13, 2021

(54) DETECTION SYSTEM BASED ON ZERO-POINT REAL-TIME REFRESHING CALCULATION FOR REAL-TIME ROTATION MEASUREMENT

(71) Applicant: Shanghai Lonham Electrical and Mechanical Technology Co.., Ltd., Shanghai (CN)

(72) Inventors: Chuanyi WANG, Shanghai (CN); Huarong LI, Shanghai (CN)

(73) Assignee: Shanghai Lonham Electrical and Mechanical Technology Co.., Ltd., Shanghai (CN)

(21) Appl. No.: 17/091,013

(22) Filed: Nov. 6, 2020

(30) Foreign Application Priority Data
Nov. 8, 2019 (CN) 201911089467.7

(51) Int. Cl. G05B 19/05; G01P 3/00

(52) U.S. Cl. CPC G05B 19/054; G05B 2219/1161; G01P 3/00

(57) ABSTRACT

A detection system based on a zero-point real-time refreshing calculation for real-time rotation measurement, includes an analog quantity sensor and a programmable logic controller (PLC). The detection system based on the zero-point real-time refreshing calculation for real-time rotation measurement further includes a storage unit and a display. The storage unit includes three common storage units. An output port of the analog quantity sensor is connected to an input port of the PLC by a data cable, and an output port of the PLC is connected to an input port of the display by a data cable. At a zero point of each sampling segment, a signal at a previous moment is acquired and then subjected to an operation to thereby obtain a real-time rotation speed and a quantity of rotations at a current moment.

### RELATED APPLICATION

This application claims priority to Chinese Patent Application Number 201911089467.7, filed Nov. 8, 2019, the contents of which are incorporated by reference in their entirety.

### TECHNICAL FIELD

The present disclosure relates to the field of rotation measurement detection technologies, and specifically, to a detection system based on a zero-point real-time refreshing calculation for real-time rotation measurement.

### BACKGROUND

A common operation mode of a widely used rotation detection device or system is as follows: a sensor (an encoder or a proximity switch) sends an analog quantity signal (formed of pulses), and the detection system reads those pulses within a time period and counts those pulses, to calculate a rotation speed and a quantity of rotations of a detected object.

This operation mode is applicable to constant-speed rotation. However, in reality, it is difficult to obtain a constant rotation speed due to factors such as part manufacturing precision. The constant rotation speed may fluctuate to an extent. In addition, in an actual operation, dynamically varying rotation speeds also need to be detected. However, using prior art methods, a large deviation may occur in these cases.

To implement real-time detection of the dynamically varying or fluctuating rotation speeds, the present disclosure is provided.

### SUMMARY

The present disclosure aims to provide a detection system based on zero-point real-time refreshing calculation for real-time rotation measurement, to resolve the problems raised above in the background.

To achieve the above purpose, the present disclosure provides the following technical approaches: a detection system based on a zero-point real-time refreshing calculation for real-time rotation measurement is provided, including an analog quantity sensor and a programmable logic controller (PLC), where the detection system based on the zero-point real-time refreshing calculation for real-time rotation measurement further includes a storage unit and a display.

The storage unit includes three common storage units, and the common storage units may be referred to as RU1, RU2, and RN.

An output port of the analog quantity sensor is connected to an input port of the PLC using a data cable, an output port of the PLC is connected to an input port of the display using a data cable, and a storage interface of the PLC is connected to the storage unit using a data cable.

One analog quantity sensor corresponds to one detected object, and the PLC corresponds to a plurality of analog quantity sensors based on a capacity and a calculation capability.

A program of the PLC sets and defines the storage unit as three common storage units, and the three common storage units are respectively referred to as RU1, RU2, and RN.

The program defines a loop execution module, including the following operations:

acquiring a specified sensor signal (a quantity of pulses) A(n);

storing the acquired value A(n) in RU2, and calculating RU2−RU1=RN;

calculating a real-time rotation speed RS(n) and a quantity RT(n) of rotations;

assigning a value of RU2 to RU1 (data transfer); and

performing next acquisition, where:
at a zero point of each sampling segment, a signal at a previous moment is acquired and then subjected to a program operation, to obtain a real-time rotation speed RS and a quantity RT of rotations at a current moment; and
the real-time rotation speed RS and the quantity RT of real-time rotations are calculated according to the following equations:

RS(n)=(RN(n)*60)/(T(n)*AT); and

RT(n)=RN(n)/AT, where
T(n) is a time length of the n^{th} sampling segment; and
   AT is a quantity of pulses/rotations.

Preferably, the analog quantity sensor may be an encoder.

Preferably, the display may be an LED display.

Preferably, a specified time length of T(n) may be one to two seconds.

Preferably, the PLC may be provided with a decoder that matches the analog quantity sensor.

Compared with the prior art, the present disclosure has the following beneficial effects:

(1) At a zero point of each sampling segment, a signal at a previous moment is acquired and then subjected to a program operation, to obtain a real-time rotation speed and a quantity of rotations at a current moment. In this way, there is no need to occupy a large amount of storage space. In addition, a sampling time interval is set more properly.

(2) Detection accuracy is improved, and authenticity of a measurement result is ensured.

### BRIEF DESCRIPTION OF DRAWINGS

FIG. 1 is a logical block diagram of a system according to the present disclosure;

FIG. 2 is a systematic logical block diagram of a storage unit according to the present disclosure; and

FIG. 3 is a diagram of data acquired in the utility mode.

### DETAILED DESCRIPTION

The following clearly and completely describes the technical solutions in the embodiments of the present disclosure with reference to accompanying drawings in the embodiments of the present disclosure. Apparently, the described embodiments are merely some rather than all of the embodiments of the present disclosure. All other embodiments obtained by a person of ordinary skill in the art based on the embodiments of the present disclosure without creative efforts shall fall within the protection scope of the present disclosure.

In the description of the present disclosure, it should be understood that orientation or position relationships indicated by terms “upper”, “lower”, “front”, “rear”, “top”, “bottom”, “inside”, “outside”, and the like are orientation or position relationships as shown in the drawings, and these terms are just used to facilitate description of the present disclosure and simplify the description, but not to indicate or imply that the mentioned apparatus or elements must have a specific orientation and must be constructed and operated in a specific orientation, and thus, these terms cannot be understood as a limitation to the present disclosure.

Embodiments are now described.

Referring to FIG. 1 and FIG. 2, the present disclosure provides a technical approach to addressing the issues with the prior art: a detection system based on a zero-point real-time refreshing calculation for real-time rotation measurement, including an analog quantity sensor and a PLC. The detection system based on the zero-point real-time refreshing calculation for real-time rotation measurement further includes a storage unit and a display.

The PLC is provided with a decoder that matches the analog quantity sensor, the display is an LED display, and the analog quantity sensor is an encoder.

The storage unit includes three common storage units, and the common storage units include RU1, RU2, and RN.

An output port of the analog quantity sensor is connected to an input port of the PLC using a data cable, an output port of the PLC is connected to an input port of the display using a data cable, and a storage interface of the PLC is connected to the storage unit using a data cable.

One analog quantity sensor corresponds to one detected object, and the PLC corresponds to a plurality of analog quantity sensors based on a capacity and a calculation capability.

A program of the PLC sets and defines the storage unit as three common storage units, and the three common storage units are respectively RU1, RU2, and RN.

The program defines a loop execution module, including the following operations:

acquiring a specified sensor signal (a quantity of pulses) A(n);

storing the acquired value A(n) in RU2, and calculating RU2−RU1=RN;

calculating a real-time rotation speed RS(n) and a quantity RT(n) of rotations;

assigning a value of RU2 to RU1 (data transfer); and

performing next acquisition.

At a zero point of each sampling segment, a signal at a previous moment is acquired and then subjected to a program operation, to obtain a real-time rotation speed RS and a quantity of rotations at a current moment.

The real-time rotation speed RS and the quantity RT of real-time rotations are calculated according to the following algorithms:

RS(n)=(RN(n)*60)/(T(n)*AT); and

RT(n)=RN(n)/AT.

T(n) is a time length of the n^{th} sampling segment, and T(n) is set to one to two seconds.

AT is a quantity of pulses/rotation.

For the measurement of rotation and a rotation speed of a target object, the analog quantity sensor (the encoder) basically generates a discrete signal—a pulse that is based upon with rotation of the target. The system acquires and counts pulses, and then calculates the rotation speed and the quantity of rotations according to a quantity of pulses and a time length of each rotation.

Details are as follows:

A(0) is a quantity of pulses at an initial detection point (zero point). Then, A(1), A(2), A(3), A(4), . . . , A(n+1), and the like are obtained through sampling under the control of the system, and then quantities of pulses increased at corresponding moments are obtained through calculation: RN(1)=A(0)−A(0), RN(2)=A(2)−A(0), RN(3)=A(3)−A(0), RN(4)=A(4)−A(0), . . . , RN(n+1)=A(n+1)−A(n), and the like.

In a case of a constant rotation speed:

In a prior art method, a zero point A(0) of the first sampling segment is shared by n sampling segments, and the system and the program update a zero point of a sampling segment after the n sampling points to A(n). Then, a quantity of pulses increased at each moment is obtained in a same method: RN(n+1)=A(n+1)−A(n), RN(n+2)=A(n+2)−A(n), RN(n+3)=A(n+3)−A(n), . . . . A zero point of each sampling segment is updated to A(n).

Each sampling time interval T may be set to be constant. If there is a constant rotation speed RT, the quantity of pulses increased at each moment is also constant. Then the rotation speed is calculated as follows:

RT(n)=RN(n+1)/1*T, RT(n+1)=RN(n+2)/2*T, RT(n+1)=RN(n+2)/2*T, . . . . In this way, a constant rotation speed is obtained at each moment. A prior art method is applicable.

However, in reality, it is difficult to obtain a constant rotation speed of an object. Considering impact of part manufacturing, control accuracy, and various factors, it is difficult to obtain a constant rotation speed in actual application. With the development of the era and a requirement of control precision, accurately measuring dynamic rotation is desired and necessary, and real rotation usually fluctuate due to an abnormality and a defect. Fluctuation may also lead to quality fluctuation. Consequently, fluctuation accumulated for a long time may lead to a serious accident and failure of a device or system.

In a case in which rotation dynamically changes:

If a detected target dynamically changes in a rotation process, for example, an acceleration process, a deceleration process, and the like that are performed under the control of the system, the process usually involves setting a plurality of sampling segments having a short time interval. In the method described herein, a zero point of each sampling segment is refreshed in real time, to obtain a change of the detected quantity of pulses of the sampling segment. Details are as follows:

A quantity of instant pulses increases: RN(n+1)=A(n+1)−A(n), RN(n+2)=A(n+2)−A(n+1), RN(n+3)=A(n+3)−A(n+2), . . . . A corresponding instant rotation speed is: RT(n+1)=RN(n+1)/T(n+1), RT(n+2)=RN(n+2)/T(n+2), T(n+3)=RN(n+2)/T(n+3), . . . . It is assumed that the following is obtained after segmented sampling in a dynamic rotation process: A(0)=0, A(1)=10, A(2)=10, A(3)=18, and A(4)=30. Each time interval T between sampling segments is one second. It is assumed that six pulses correspond to one rotation of the detected target. It should be noted that values in segments A(1) and A(2) are the same. This means that rotation is not actually performed in the segments A(1) and A(2).

The instant rotation speed RT and the quantity RS of rotations obtained through segment-by-segment zero-point refreshing are respectively as follows:

Similarly, values acquired for a plurality of times {at an interval of one second} are: A(0)=0, A(1)=10, A(2)=10, A(3)=18, A(4)=30, RN(1)=A(1)−A(0), RN(2)=A(2)−A(1), RN(3)=A(3)−A(2), . . . , and RN(4)=A(4)−A(3). The following results are obtained according to RS=RN/6 (unit: rotation) and RT=RS/T (unit: a quantity of rotations/second):

RN(1)=10, RN(2)=0, RN(3)=8, and RN(4)=12 (a quantity of pulses);

RS(1)=10/6, RS(2)=0, RS(3)=8/6, and RS(4)=2 (a quantity of rotations); and

RT(1)=1.67, RT(2)=0, RT(3)=1.33, and RT(4)=2.0 (a quantity of rotations/second).

However, a rotation speed and a quantity of rotations obtained in an existing method (that is, a zero point A(0) of the first sampling segment is shared by n sampling segments) are respectively as follows:

Acquisition is performed for a plurality of times (at an interval of one second), to obtain: A(0)=0, A(1)=10, A(2)=10, A(3)=18, and A(4)=30.

RS(0-1)=10, RS(0-2)=10, RS(0-3)=18, and RS(0-4)=30 (a quantity of rotations);

Rotation speeds are as follows: RT(0-1)=RS(0-1)/1*T*6=1.67;

RT(0-2)=RS(0-2)/2*T*6=0.83;

RT(0-3)=RS(0-3)/3*T*6=1.0; and

RT(0-4)=RS(0-4)/4*T*6=1.25.

However, if acquisition is performed only at a start point and an end point in a same time length in the existing measurement method, a rotation speed and a quantity of rotations obtained are respectively:

RS (one time of acquisition)=30 (rotations)/RT (one time of acquisition)=30/4*1*6=1.25 (rotations/second).

A result comparison is as follows:

Every six pulses of the detected target correspond to one
rotations Sampling information of the detected target

| | | | | | |
|---|---|---|---|---|---|
| Value A at each | 0 | 10 | 10 | 18 | 30 |
| point (a quantity of | | | | | |
| pulses) | | | | | |
| Time interval | 1 | 1 | 1 | 1 | 1 |
| (second) | | | | | |

Serial 1-Results obtained through segment-by-segment zero-point
real-time refreshing and multi-segment detection (real-time
rotation speeds and quantities of rotations)

| | | | | | |
|---|---|---|---|---|---|
| Quantity of | | 10 | 0 | 8 | 12 |
| rotations of each | | | | | |
| sampling segment | | | | | |
| Real-time rotation | Rotations/second | 1.67 | 0 | 1.33 | 2.0 |
| speed of each | | | | | |
| sampling segment | | | | | |

Serials 2 and 3 - Results obtained in an existing method
through multi-point acquisition and one time of acquisition
(rotation speeds and quantities of rotations)

| | | | | | |
|---|---|---|---|---|---|
| Accumulated | | 10 | 10 | 18 | 30 |
| rotations of each | | | | | |
| sampling segment | | | | | |
| Rotation speed of | Rotations/second | 1.67 | 0.83 | 1.0 | 1.25 |
| each sampling | | | | | |
| segment | | | | | |

| | |
|---|---|
| Serial 3 - Results obtained through | 30 rotations/4 seconds→125 |
| only one time of acquisition other than | rotations/second |
| acquisition performed at the zero point: | |

Therefore, an accurate measurement result cannot be obtained in a prior art measurement method during dynamic rotation of the detected target. In addition, in the prior art measurement detection method, a dynamic change in the detected rotation process is covered and compromised to an extent. Consequently, the device and a monitor cannot know an actual authenticity case of the rotation process of the detected target.

In addition, automatic control and even closed-loop control have been widely used in practice. These control mechanisms automatically and reversely compensate for fluctuations that occur. In prior art measurement and detection methods (the zero point remains unchanged), the system operates very stably. However, fluctuations exist and are compensated for alternately. Some fluctuations fall within a requirement range, but some fluctuations are beyond the requirement range due to factors such as abrasion of parts. This leads to a potential problem in operation.

The detection system based on zero-point real-time refreshing calculation for real-time rotation measurement addresses these issues, and includes an analog quantity sensor (an encoder) and a PLC. One analog quantity sensor corresponds to one detected target. The PLC may correspond to a plurality of analog quantity sensors based on a capacity and a calculation capability.

With the help of the PLC and corresponding programming, zero-point refreshing at each sampling moment is implemented through program setting. Details are as follows:

A program sets and defines three common storage units that are respectively RU1, RU2, and RN.

The program defines a loop execution module, including the following operations:

acquiring a specified sensor signal (a quantity of pulses) A(n);

storing the acquired value A(n) in RU2, and calculating RU2−RU1=RN;

calculating a real-time rotation speed RS(n) and a quantity RT(n) of rotations;

assigning a value of RU2 to RU1 (data transfer); and performing next acquisition.

In this way, at a zero point of each sampling segment, a signal at a previous moment is acquired and then subjected to a program operation, to obtain a real-time rotation speed and a quantity of rotations at a current moment. In this way, there is no need to occupy a large amount of storage space. In addition, a sampling time interval is set more properly.

The real-time rotation speed RS and the quantity RT of real-time rotations are calculated according to the following algorithm:

RS(n)=(RN(n)*60)/(T(n)*AT)(unit: rotations/minute); and

RT(n)=RN(n)/AT (unit: rotation).

T(n)—Time length of the n^{th} sampling segment (which is preset, and is usually one to two seconds); and

AT—Quantity of pulses/rotation (preset).

In this way, a real-time rotation speed and a quantity of rotations of each sampling segment are obtained. Certainly, a shorter interval provides higher precision. However, a time interval needs to be properly set. One to two seconds are proper, to verify validity of zero-point refreshing.

Data obtained in this technique is shown in FIG. 3.

The detection system based on zero-point refreshing obtains 15 groups of data, and a value obtained after weighted calculation is 52.23. A difference between the value and the following manually detected value (a weight is translated into a volume) is 0.1%.

In comparison, a value obtained after translation using a prior art method 1—detection through manual weighting (density A is 1.33, and density B is 1.13) is 52.26.

Prior art method 2—Obtaining monitoring data of an imported automatic device. An imported device obtains only one group of monitoring data, and a value is 52.8. There is an obvious deviation. In addition, in this case, the deviation has a totally different meaning.

The foregoing displays and describes basic principles, main features, and advantages of the present disclosure. Apparently, for a person skilled in the art, the present disclosure is not limited to details of the above example embodiments, and that the present disclosure may be implemented in other specific forms without departing from the spirit or basic features of the present disclosure. Therefore, the embodiments should be regarded as an example and non-limiting in every respect, and the scope of the present disclosure is defined by the appended claims rather than the above description, all changes falling within the meaning and scope of equivalent elements of the claims should be included in the present disclosure, and any reference numbers in the claims should not be construed as a limitation to the involved claims.

Although the embodiments of the present disclosure have been illustrated and described, it should be understood that a person of ordinary skill in the art may make various changes, modifications, replacements, and variations to the above examples without departing from the principle and spirit of the present disclosure, and the scope of the present disclosure is limited by the appended claims and equivalents thereof.

1. A detection system based on a zero-point real-time refreshing calculation for real-time rotation measurement, the detection system comprising:
an analog quantity sensor, a programmable logic controller (PLC), a storage unit, and a display;
wherein the storage unit comprises three common storage units, and the common storage units comprising RU1, RU2, and RN;
wherein an output port of the analog quantity sensor is connected to an input port of the PLC using a data cable, an output port of the PLC is connected to an input port of the display using a data cable, and a storage interface of the PLC is connected to the storage unit using a data cable;
wherein the analog quantity sensor is associated with one detected object, and the PLC is associated with a plurality of analog quantity sensors based on a capacity and a calculation capability;
wherein the PLC is configured to define the storage unit as three common storage units, and the three common storage units are respectively RU1, RU2, and RN; and
wherein the PLC is further configured to define a loop execution module, the loop execution module performing the following operations:
acquiring a sensor signal containing a quantity of pulses A(n);
storing A(n) in RU2, and calculating a value RN as being equal to a difference between the contents of RU2 and RU1 as RN=RU2−RU1;
calculating a real-time rotation speed RS(n) of the detected object and a quantity RT(n) of rotations of the detected object;
transferring contents of RU2 to RU1; and
performing a next acquisition, wherein
at a zero point of each sampling segment n, a signal at a previous moment is acquired and then subjected to an operation, to obtain a real-time rotation speed RS and a quantity RT of rotations at a current moment; and
wherein the real-time rotation speed RS(n) and the quantity RT(n) of real-time rotations are calculated according to the following equations:
RS(n)=(RN(n)*60)/(T(n)*AT); and
RT(n)=RN(n)/AT, wherein
T(n) is a time length of the n^{th} sampling segment;
RN(n) is the contents of RN at the nth sampling segment and
AT is a quantity of pulses of the sensor signal and/or rotations of the detected object.

2. The detection system based on the zero-point real-time refreshing calculation for real-time rotation measurement according to claim 1, wherein the analog quantity sensor is an encoder.

3. The detection system based on the zero-point real-time refreshing calculation for real-time rotation measurement according to claim 1, wherein the display is an LED display.

4. The detection system based on the zero-point real-time refreshing calculation for real-time rotation measurement according to claim 1, wherein the time length of T(n) is one to two seconds.

5. The detection system based on the zero-point real-time refreshing calculation for real-time rotation measurement according to claim 1, wherein the PLC is provided with a decoder that matches the analog quantity sensor.

6. The detection system based on the zero-point real-time refreshing calculation for real-time rotation measurement according to claim 1, wherein the PLC is further configured to determine whether the detected object has dynamically changed its rotation process based upon the real-time rotation speed and the quantity of real-time rotations, and causing the object to undergo an acceleration process or a deceleration process based thereupon.
